(19) United States
(12) Patent Application Publication
(10) Pub. No.: US 2010/0127489 A1
(43) Pub. Date: May 27, 2010

(54) NOTEBOOK WITH HOLDER FORMED FROM COVER

(75) Inventor: Lawrence Edward O'Boyle, Charlotte, NC (US)

Correspondence Address: ADAMS INTELLECTUAL PROPERTY LAW, Suite 2350 Charlotte Plaza, 201 South College Street, CHARLOTTE, NC, 28244, US

(73) Assignee: TIMEPLANNER CALENDARS, INC., Charlotte, NC (US)

(21) Appl. No.: 12/323,112

(22) Filed: Nov. 25, 2008

(51) Int. Cl. B42D 3/00; B42C 11/00

(52) U.S. Cl. 281/31; 281/29; 412/4; 412/1

(57) ABSTRACT

A notebook includes a front cover, a back cover, an insert retaining panel, and an implement holder. The front and back covers each have first and second major sides and are movable relative to each other between open and closed positions. The panel cooperates with the back cover to form a pocket to receive an insert between the back cover and the panel. The implement holder is formed from a flap portion of the back cover into a sleeve for retaining an implement therein. The front cover and back cover are integrally formed and are foldable along at least one crease therebetween, and the panel is an integrally formed extension of the back cover. The flap defines a raised edge forming a stop against which an edge of an insert rests for proper positioning of the insert between the front and back covers. The notebook includes a spine integrally formed with the front cover and the back cover.

### FIELD OF THE INVENTION

The invention relates generally to a notebook that includes a holder for an implement such as a writing utensil, and more particularly relates to a notebook having a cover from which an implement holder is formed.

### BACKGROUND OF THE INVENTION

A notebook having a pen holder is useful to a consumer so that a pen is readily available when, for example, notes are to be taken or calendar entries are to be made. Although notebooks having pen holders are available, a typical conventional example includes some sort of loop, which may be stretchable, to serve as the pen holder. Such loops require additional manufacturing materials over that of the notebook cover and often wear out allowing pens to be lost.

There is a need for a notebook having a cover from which an implement holder is formed so as to minimize materials and steps in manufacturing of the notebook. There is a need for a notebook having an implement holder constructed of the same durable materials as that by which the notebook is constructed.

### BRIEF SUMMARY OF THE INVENTION

It is an object of the present invention to provide a notebook having a cover from which an implement holder is formed. Furthermore, it is an object of the present invention to provide a notebook having an implement holder constructed of the same durable materials as that by which the cover of the notebook is constructed. These and other objects are achieved in the embodiments described below.

According to at least one embodiment of the invention, a notebook includes a front cover, a back cover, an insert retaining panel, and an implement holder. The front and back covers each have first and second major sides and are movable relative to each other between open and closed positions. The insert retaining panel cooperates with the back cover to form a pocket to receive an insert between the back cover and the panel. The implement holder is formed from a flap portion of the back cover into a sleeve for retaining an implement therein. In at least one example, the front cover and back cover are integrally formed and are foldable along at least one crease therebetween, and the panel is an integrally formed extension of the back cover. The flap in at least one embodiment defines a raised edge forming a stop against which an edge of an insert rests for proper positioning of the insert between the front and back covers. The notebook may include a spine integrally formed with the front cover and the back cover.

According to another embodiment of the invention, a blank for forming a notebook has a front cover, a back cover and an integrally formed spine therebetween. The blank includes a front cover, a back cover, a spine connecting the front cover to the back cover, a panel and a flap. The panel is integrally formed with the back cover opposite the spine for cooperating with the back cover to form a pocket to receive an insert between the back cover and the panel. The flap is integrally formed with the back cover opposite the spine for forming a sleeve for retaining an implement therein. In at least one example, a U-shaped cut separates the panel and the flap, and the panel defines a U-shape positioned around the U-shaped cut.

According to yet another embodiment of the invention, a method is provided for forming a notebook having a front cover, a back cover and an integrally formed spine therebetween. The method includes providing a blank having a front cover, a back cover, a spine, a panel and a flap. The spine, which connects the front cover to the back cover, is positioned between and is integrally formed with the front cover and the back cover. The panel and the flap are each integrally formed with the back cover opposite the spine. In the method, the panel is folded into overlying relation to the back cover to form a pocket for receiving an insert between the panel and back cover, and the flap is folded toward the back cover to form an implement holder for retaining an implement therein. In at least one example, the flap is folded at multiple creases to form the implement holder. In at least one example, the flap is folded to define a raised edge forming a stop against which an edge of an insert rests for proper positioning between the front and back covers.

### BRIEF DESCRIPTION OF THE DRAWINGS

Various embodiments and many features and advantages of the present invention are better understood when the following detailed description is read with reference to the accompanying drawings, in which:

FIG. 1 is a plan view of a blank for forming a notebook according to one embodiment of the present invention;

FIG. 2 is a perspective view of the blank of FIG. 1;

FIG. 3 is a perspective view of FIG. 1, shown with a panel being folded toward a back cover of the blank;

FIG. 4 is a perspective view of FIG. 1, shown with the panel folded into overlying relation with the back cover;

FIG. 5 is a partial perspective view of FIG. 1, shown with a flap being folded toward the back cover;

FIG. 6 is a partial perspective view of FIG. 1, shown with the flap folded to form an implement holder;

FIG. 7 is a partial perspective of the implement holder of FIG. 6 retaining a writing utensil;

FIG. 8 is a plan view of a notebook according to at least one embodiment of the invention receiving an insert;

FIG. 9 is a plan view of the notebook of FIG. 8 shown retaining a writing utensil and an insert;

FIG. 9A is a detailed plan view of a portion of the notebook of FIG. 9;

FIG. 10 is a cross-sectional view taken along lines 10-10 of FIG. 9; and

FIG. 11 is a partial perspective view of an implement holder according to another embodiment of the invention.

### DETAILED DESCRIPTION OF THE INVENTION

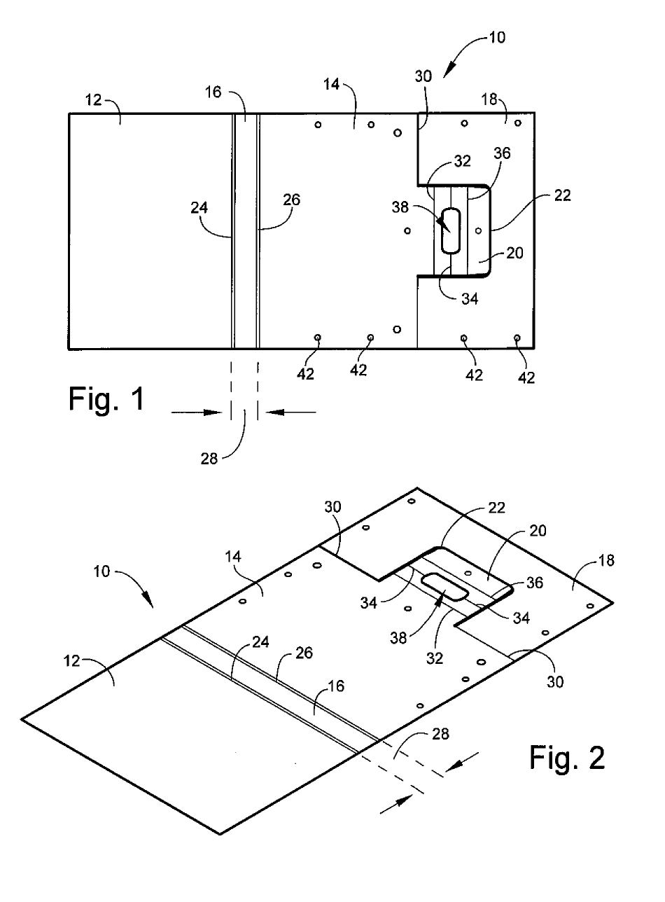

Referring to the drawings wherein identical reference numerals denote the same elements throughout the various views, FIGS. 1 and 2 illustrate, according to one embodiment of the present invention, a blank 10 for forming a notebook. The blank 10 includes a front cover 12, a back cover 14, a spine 16 connecting the front cover 12 to the back cover 14, a panel 18 for cooperating with the back cover 14 to form a pocket, and a flap 20 for forming a sleeve for retaining an implement such as a writing utensil. The spine 16 is positioned between the front cover 12 and the back cover 14, and is integrally formed with the front cover 12 and the back cover 14. The panel 18 and the flap 20 are each integrally formed with the back cover 14 opposite the spine 16.

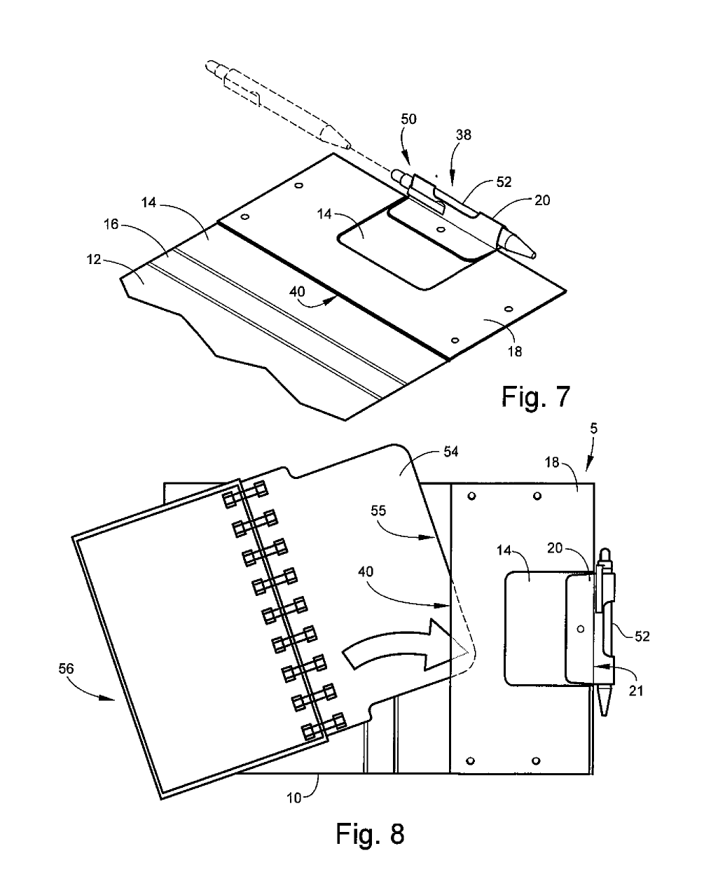

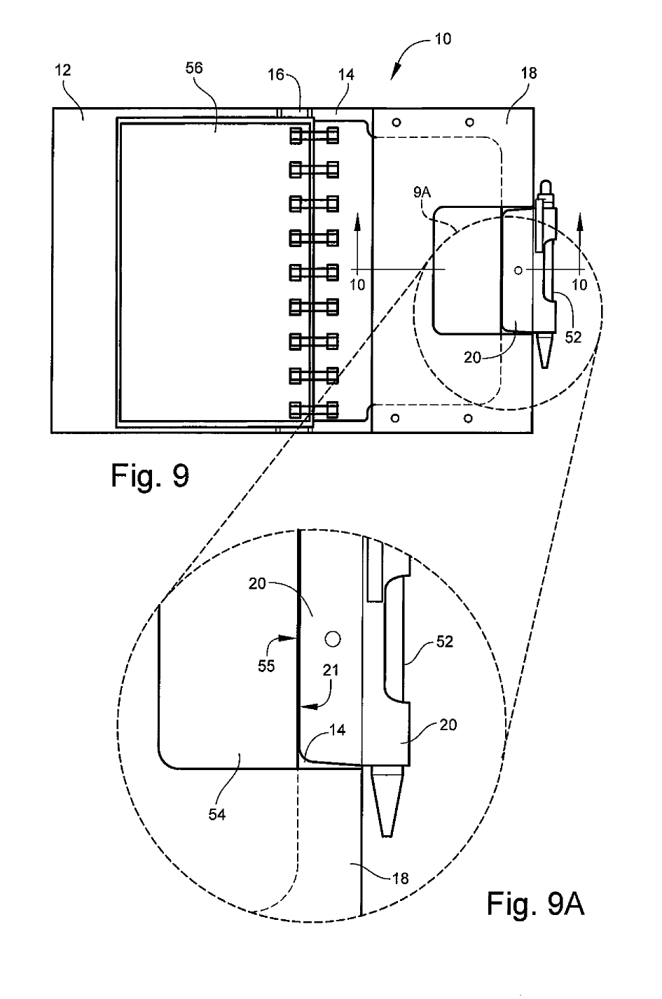

A U-shaped cut 22 separates the panel 18 and the flap 20. The panel 18 defines a U-shape positioned around the U-shaped cut 22, and the flap 20 defines a U-shaped tab cut from and partially surrounded by the panel 18. The spine 16 is connected to the front cover 12 and the back cover 14 along a pair of weakness lines 24, 26 for forming hinges between the front cover 12 and back cover 14. The weakness lines 24, 26 are spaced to define the thickness 28 of the notebook 5 (FIG. 9). A slot 38 is formed through the flap 20 for purposes first illustrated in FIG. 7.

The blank 10 of FIGS. 1, 2 may be die-cut from a sheet of material or formed by other manufacturing techniques. To facilitate the formation of the notebook 5 from the blank 10, weakness lines 24, 26, 30, 32, 34, and 36 may be formed by creasing, perforating, partially cutting, or otherwise weakening the base material of the blank so as to prepare the blank for folding.

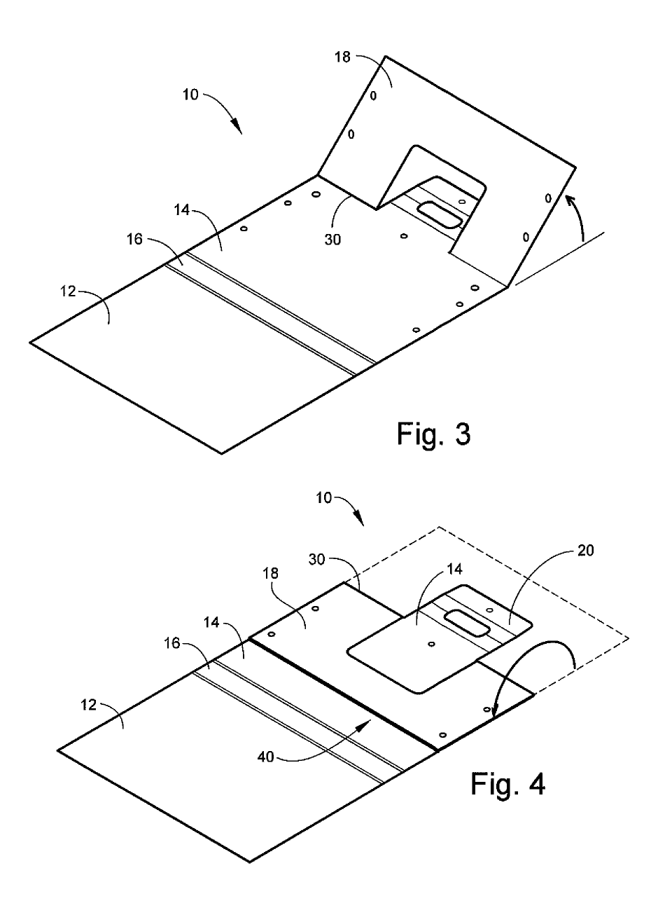

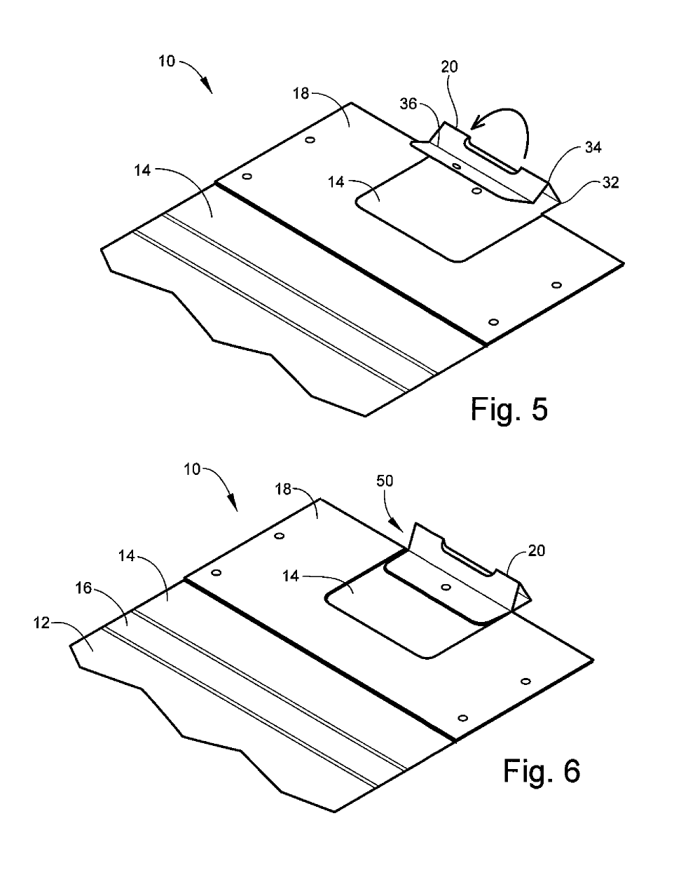

FIGS. 3-6 proceed from FIGS. 1-2 to illustrate a method of forming the notebook 5 (FIG. 9). In FIG. 3, the panel 18 is shown being folded along the weakness line 30 toward the back cover 14. In FIG. 4, the panel 18 is shown folded into overlying relation to the back cover 14 to form a pocket 40 between the panel 18 and the back cover 14 for receiving an insert 54 (FIG. 8). In FIG. 5, the flap 20 is shown being folded, along multiple creases 32, 24 toward the back cover 14. In FIG. 6, the folding of the flap 20 is complete such that an implement holder 50 is formed. As the flap 20 is folded upon itself the flap 20 forms a sleeve with an internal void for receiving an implement such as a writing utensil.

In FIG. 7, an implement 52 is retained by the implement holder 50. The slot 38 permits viewing of the body portion of the writing utensil 52 and receives a clip of the writing utensil 52 to help keep the writing utensil 52 retained. Although the implement holder 50 is shown in FIG. 6 as having three sides, other implement holders may be formed. For example, a round implement holder 150 is shown retaining the writing utensil 52 in FIG. 11. A round or other shaped implement holder may be formed, for example, by rolling or folding the flap 20 around a round mandrel or a mandrel of some other desired shape.

The pocket 40 formed by the panel 18 and the back cover 14 is maintained by a connection between the panel 18 and the back cover 14. The connection may be formed by a rivet, a staple, an adhesive, or sonic welding. Holes 42 are shown in FIG. 1 as formed through the back cover 14 and in corresponding locations through the panel 18 for passing rivets or other connectors through the holes 42 so as to maintain the connection between the panel 18 and the back cover 14.

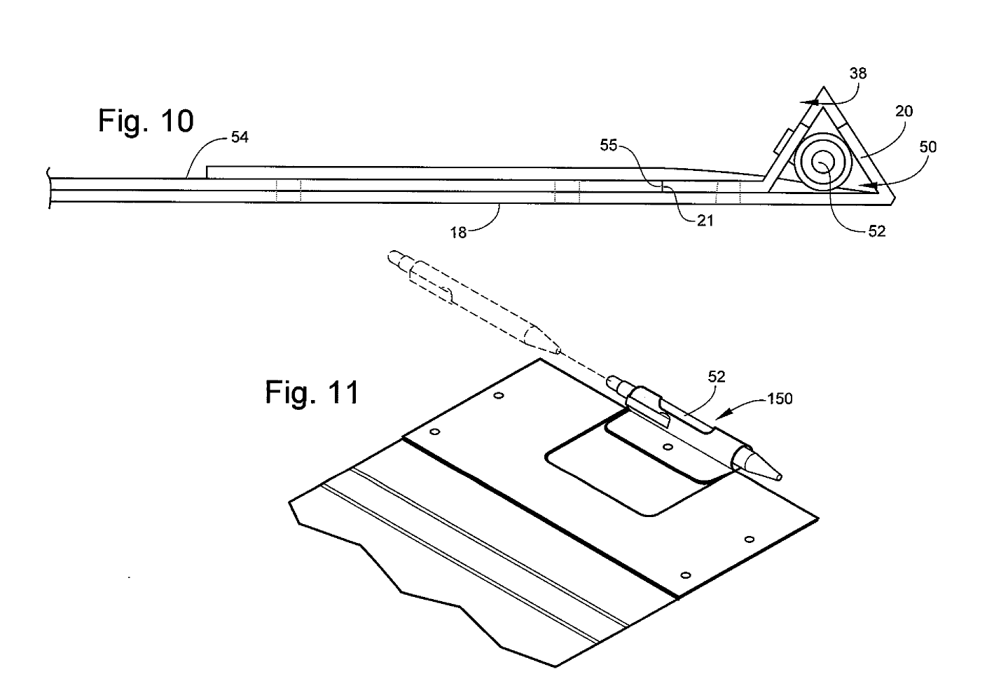

A notebook 5 formed from the blank 10 is shown in FIG. 8, in which an insert 54 is being positioned into the pocket 40. The insert 54 in the illustrated example is the back cover of a booklet 56 that may be a calendar, a diary, a journal, a log, a sketch collection, or some other article. Though the insert 54 is illustrated as a booklet, it more generally represents some portion of an article to be protected and carried by the notebook 5. For example, the insert 54 also represents an electronic device such as a personal digital assistant (PDA) and the implement 52 also represents a stylus for use with the PDA. In FIG. 9, the insert is properly positioned in the notebook 5. As shown in FIGS. 9A and 10, the flap 20 defines a raised edge 21 against which an edge 55 of the insert 54 rests for proper positioning of the insert 54.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A notebook comprising:
a. a front cover and a back cover each having first and second major sides and movable relative to each other between open and closed positions;
b. an insert retaining panel cooperating with the back cover to form a pocket to receive an insert between the back cover and the panel; and
c. an implement holder formed from a flap portion of the back cover into a sleeve for retaining an implement therein.

2. A notebook according to claim 1, wherein the front cover and back cover are integrally formed and are foldable along at least one crease therebetween.

3. A notebook according to claim 1, wherein the panel comprises an integrally formed extension of the back cover.

4. A notebook according to claim 1, wherein the flap is formed from a U-shaped tab cut from the panel and folded out of a plane of the panel.

5. A notebook according to claim 1, wherein the implement holder comprises a sleeve formed by folding the flap upon itself to form a void.

6. A notebook according to claim 1, wherein the pocket formed by the panel and back cover is maintained by at least one connection between the panel and back cover.

7. A notebook according to claim 6, wherein the connection is selected from a group consisting of a rivet, a staple, an adhesive, and sonic welding.

8. A notebook according to claim 1, wherein the flap defines a raised edge forming a stop against which an edge of an insert rests for proper positioning of the insert between the front and back covers.

9. A notebook according to claim 1, and further comprising a spine integrally formed with the front cover and the back cover.

10. A notebook according to claim 9, wherein the sleeve is integrally formed with and projects outwardly from the back cover.

11. A blank for forming a notebook having a front cover, a back cover and an integrally formed spine therebetween, the blank comprising:
a. a front cover;
b. a back cover;
c. a spine connecting the front cover to the back cover, the spine positioned between and integrally formed with the front cover and the back cover;
d. a panel integrally formed with the back cover opposite the spine for cooperating with the back cover to form a pocket to receive an insert between the back cover and the panel; and
e. a flap integrally formed with the back cover opposite the spine for forming a sleeve for retaining an implement therein.

12. A blank according to claim 11, wherein a U-shaped cut separates the panel and flap.

13. A blank according to claim 12, wherein the panel defines a U-shape positioned around the U-shaped cut.

14. A blank according to claim 11, wherein the spine is connected to the front cover and the back cover along a pair of weakness lines for forming hinges between the front cover and back cover, and the weakness lines are spaced to define the thickness of the notebook.

15. A method of forming a notebook having a front cover, a back cover and an integrally formed spine therebetween, the method comprising:
a. providing a blank comprising:
i. a front cover;
ii. a back cover;
iii. a spine connecting the front cover to the back cover and positioned between and integrally formed with the front cover and the back cover;
vi. a panel integrally formed with the back cover opposite the spine; and
v. a flap integrally formed with the back cover opposite the spine;
b. folding the panel into overlying relation to the back cover to form a pocket for receiving an insert between the panel and back cover;
c. folding the flap toward the back cover to form an implement holder for retaining an implement therein.

16. A method according to claim 15, wherein folding the flap toward the back cover comprises folding the flap at multiple creases to form the implement holder.

17. A method according to claim 15, wherein upon folding the flap to form the implement holder, the flap defines a raised edge forming a stop against which an edge of an insert rests for proper positioning between the front and back covers.

18. A method according to claim 15, wherein the implement holder comprises a sleeve positioned on an end edge of the back cover and projects outwardly therefrom.
